(19) United States
(12) Patent Application Publication
(10) Pub. No.: US 2019/0120105 A1
(43) Pub. Date: Apr. 25, 2019

(54) EXHAUST PURIFYING DEVICE FOR INTERNAL COMBUSTION ENGINE

(71) Applicant: HONDA MOTOR CO., LTD., Tokyo (JP)

(72) Inventors: Yoshiaki Hatakeyama, Wako-shi (JP); Hiroki Yokoyama, Wako-shi (JP)

(73) Assignee: HONDA MOTOR CO., LTD., Tokyo (JP)

(21) Appl. No.: 16/166,469

(22) Filed: Oct. 22, 2018

(30) Foreign Application Priority Data
Oct. 23, 2017 (JP) 2017-204572
Feb. 5, 2018 (JP) 2018-018394

(51) Int. Cl. F01N 3/022; B01D 46/24; B01J 35/04

(52) U.S. Cl. CPC F01N 3/0222; B01D 46/2429; F01N 2330/30; B01D 46/2422; F01N 2330/06; B01J 35/04

(57) ABSTRACT

An exhaust purifying device provided in an exhaust passage of an internal combustion engine comprises: a column-shaped honeycomb carrier; a cylindrical case member adapted to house the honeycomb carrier; a holding member provided between the honeycomb carrier and the case member to surround the outer circumference of the honeycomb carrier; buffer members provided on a peripheral edge of the edge surface of at least one side of an inflow side edge surface and an outflow side edge surface of the honeycomb carrier so as to regulate the movement of the honeycomb carrier in the central axis X direction; and setting members secured to the case member to regulate the movement of the buffer members by allowing their position regulation parts to contact the buffer members; wherein the buffer members are provided, on the outer circumferential sides, with recesses into which the position regulation parts of the setting members are fitted.

### CROSS REFERENCES TO RELATED APPLICATIONS

The present application claims priority under 35 U.S.C. § 119 to Japanese Patent Application No. 2017-204572, filed Oct. 23, 2017, entitled “EXHAUST PURIFYING DEVICE FOR INTERNAL COMBUSTION ENGINE” and Japanese Patent Application No. 2018-018394, filed Feb. 5, 2018, entitled “EXHAUST PURIFYING DEVICE FOR INTERNAL COMBUSTION ENGINE” The contents of these applications are incorporated herein by reference in their entirety.

### TECHNICAL FIELD

The present disclosure relates to an exhaust purifying device for an internal combustion engine.

### BACKGROUND

Conventionally, an exhaust purifying device provided in an exhaust passage of an internal combustion engine is constituted by including a carrier (a honeycomb carrier) in which an exhaust purifying catalyst is carried and a cylindrical case member adapted to house the carrier therein. In the case of housing the carrier within the case member, it is important to firmly hold the carrier within the case member. For this reason, it is known that a holding member commonly known as a mat is caused to lie between an inner circumferential surface of the case member and an outer circumferential surface of the carrier and a stopper member is provided on each edge periphery of inflow and outflow sides of exhaust in the carrier. A buffer member is inserted between the stopper member and the carrier (e.g., refer to Japanese published unexamined application No. 2013-160149).

In order to strengthen coupling of a ring-shaped stopper member with an edge inner circumferential surface of a cylindrical case member, when a contact area of both members is made larger, the case member is extended in the axial direction of the cylindrical body and as a result, the exhaust purifying device becomes longer as a whole and miniaturization of the device is inhibited. For this reason, in the exhaust purifying device of Japanese published unexamined application No. 2013-160149, one part of a ring-shaped stopper member is divided to have a C-shape. Once the C-shaped stopper member is reduced in diameter, it is then press-fitted into the edge section of the cylindrical case member. After press-fitting is completed, the diameter of the stopper member is increased to make a pressure contact with the inner circumferential surface of the case member. In addition, in such a pressure contact condition, the stopper member is welded to the edge section of the case member by welding. At this time, it is said that, since the stopper member is installed in such a position that it enters the inside from the edge section of the cylindrical case member, a total length of the exhaust purifying device is shortened.

### SUMMARY

The inventous found that, in the technique of Japanese published unexamined application No. 2013-160149, a stopper member is caused to weld to an edge section of a case member by welding, but it is not desirable in terms of durability to perform welding at an area of the edge section of the case member which repeats expansion or contraction under the effect of heat. Also, since welding is an essential process, production efficiency is inhibited.

Thus, it is desirable to provide an exhaust purifying device for an internal combustion engine which is excellent in durability and has good production efficiency.

To attain the above-mentioned, the following techniques are proposed.

(1) An exhaust purifying device (e.g., an exhaust purifying device 1 described later) provided in an exhaust passage of an internal combustion engine to purify exhaust of the internal combustion engine comprises: a column-shaped honeycomb carrier (e.g., a honeycomb carrier 11 described later) in which a plurality of cells extending from an inflow side edge surface (e.g., an inflow side edge surface 110a described later) to an outflow side edge surface (e.g., an outflow side edge surface 110b described later) of exhaust to become a flow passage of the exhaust are provided to allow porous partitions to form compartments therein; a cylindrical case member (e.g., a case member 12 described later) adapted to house the honeycomb carrier therein; a holding member (e.g., a holding member 13 described later) provided between the honeycomb carrier and the case member so as to surround the outer circumference of the honeycomb carrier; a buffer member (e.g., buffer members 14a, 14b described later) provided on a peripheral edge of the edge surface of at least one side of the inflow and outflow side edge surfaces of the honeycomb carrier to regulate the movement of the honeycomb carrier in the central axis (e.g., a central axis X described later) direction; and a setting member (e.g., setting members 15a, 15b described later) secured to the case member to regulate the movement of the buffer member by allowing its position regulation part (e.g., position regulation parts 151a, 151b described later) to contact the buffer member; wherein the buffer member is provided with a recess (e.g., recesses 141a, 141b described later) into which the position regulation part of the setting member is fitted.

In the exhaust purifying device for an internal combustion engine of the item (1) above, the buffer member is provided on a peripheral edge of the edge surface of at least one side of an inflow and outflow side edge surfaces of the honeycomb carrier so as to regulate the movement of the honeycomb carrier in the central axis direction. Further, a setting member is provided so as to regulate the movement of the buffer member. The setting member is secured to the case member and has a position regulation part designed to contact the buffer member. The buffer member is provided with a recess into which the position regulation part of the setting member is fitted. Accordingly, the buffer member is provided in such a manner that its position is regulated under the sufficient regulation force by allowing the position regulation part of the setting member to be fitted into the recess. Therefore, without using a technique like welding which has a problem with durability, the buffer member can be maintained in a predetermined position and as a result, the exhaust purifying device is excellent in durability. Also, without performing welding or the like, since the position regulation part of the setting member is caused to be fitted into the recess of the buffer member, a process for performing welding or the like can be omitted and production efficiency is good.

(2) The exhaust purifying device for an internal combustion engine according to item (1) is provided, in which at least one part of a fitting section of the position regulation part of the setting member to be fitted into the recess of the buffer member of the honeycomb carrier reaches a position of the inner circumferential side than the outer circumferential surface (e.g., outer circumferential surface 11P described later) of the honeycomb carrier.

In the exhaust purifying device for an internal combustion engine of the item (2) above, at least one part of the fitting section of the position regulation part to be fitted into the recess of the buffer member of the honeycomb carrier reaches a position of the inner circumferential side than the outer circumferential surface of the honeycomb carrier. Accordingly, even though stress is applied from the honeycomb carrier side, it is possible to effectively prevent the deformation or slip-off of the buffer member.

(3) The exhaust purifying device for an internal combustion engine according to item (1) or item (2) is provided, in which the position regulation part of the setting member, in a cross-section view of the honeycomb carrier in the radial direction, extends to the inner circumferential side than the outer circumferential surface of the honeycomb carrier, facing toward the central axis of the honeycomb carrier from its outer circumferential end and it is then folded back to the outside.

In the exhaust purifying device for an internal combustion engine of the item (3) above, the position regulation part of the setting member, in a cross-sectional view of the honeycomb carrier in the radial direction, extends to the inner circumferential side than the outer circumferential surface of the honeycomb carrier, facing toward the central axis of the honeycomb carrier from its outer circumferential end and it is then folded back to the outside. Thus, the setting member can firmly embrace the buffer member and as a result, it is possible to cause the setting member to hold the buffer member more tightly. It is therefore possible to effectively prevent the deformation or slip-off of the buffer member.

(4) The exhaust purifying device for an internal combustion engine according to item (1) or item (2), wherein an edge ring member (e.g., the edge ring member 16a described later) with a cylindrical section fitted onto the outer circumferential side of a fitting body of the buffer member and the setting member is provided, and the setting member, in a cross-section view of the honeycomb carrier in the radial direction, has an extension (e.g., an extension 156e described later) extending in a direction away from the honeycomb carrier along the inner circumferential surface of the cylindrical section (e.g., the cylindrical section 161e) of the edge ring member.

In the exhaust purifying device for an internal combustion engine of the item (4) above, since the cylindrical section of the edge ring member and the setting member can be welded at the extension extending in a direction away from the honeycomb carrier, welding of the edge ring member to the setting member is performed easily and the buffer member is less subject to heat damage by welding.

(5) The exhaust purifying device for an internal combustion engine according to any one of items (1) to (4) is provided, in which the setting member is provided, at its position regulation part, with a projection (e.g., a projection 154a described later) projecting toward the honeycomb carrier.

According to the exhaust purifying device for an internal combustion engine of the item (5) above, by allowing the projection to strongly engage with the recess of the buffer member, it is possible to strongly prevent the deformation or slip-off of the buffer member.

(6) The exhaust purifying device for an internal combustion engine according to any one of items (1) to (5) is provided, in which the buffer member is formed in an annular shape in a view of the honeycomb carrier in the central axis direction and at least one part is divided.

According to the exhaust purifying device for an internal combustion engine of the item (6) above, since the deformation of the buffer member is performed easily at assembling because of the existence of an part of an aperture by the division, production efficiency is good and it is possible to absorb the deformation at the part of the aperture, thereby being capable of reducing the distortion of the setting member and the case member at the time of hot working.

(7) The exhaust purifying device for an internal combustion engine according to any one of items (1) to (3), (5), and (6) is provided, in which the setting member is the same member as the case member.

According to the exhaust purifying device for an internal combustion engine of the item (7) above, since a part of the case member itself constitutes the setting member, the number of parts is reduced and the number of welding spots is reduced as a result, further improvement of production efficiency is attained.

(8) The exhaust purifying device for an internal combustion engine according to any one of items (1) to (6) is provided, in which the setting member is provided in such a manner that the position regulation part is formed in an annular shape in a view of the honeycomb carrier in the central axis direction and at least one part is divided.

According to the exhaust purifying device for an internal combustion engine of the item (8) above, since the deformation of the position regulation part in the setting member is performed easily at assembling because of the existence of an aperture by the division, production efficiency is good and it is possible to absorb the deformation at a part of the aperture produced by the division, thereby being capable of reducing the distortion of the setting member and the case member at the time of hot working.

(9) The exhaust purifying device for an internal combustion engine according to any one of items (1) to (8) is provided, in which the honeycomb carrier is a gasoline articulate filter.

According to the exhaust purifying device for an internal combustion engine of the item (9) above, the honeycomb carrier which is the gasoline articulate filter is properly held by the buffer member and protected against damage.

(10) The exhaust purifying device for an internal combustion engine according to any one of items (1) to (9), wherein at least a part of the peripheral wall of the edge ring member is provided with a projection projecting toward the buffer member.

According to the exhaust purifying device for an internal combustion engine of the item; (10) above, since the projection formed on the peripheral wall of the edge ring member is provided to press the buffer member, the buffer member is brought into close contact with the setting member. As a result, a sufficient position holding force of the setting member to the buffer member is secured. Accordingly, there is no risk that the buffer member rotates in the circumferential direction relative to the setting member.

According to the present disclosure, it is possible to embody an exhaust purifying device for an internal combustion engine which is excellent in durability and has good production efficiency. In the above explanation of the exemplary embodiment, specific elements with their reference numerals are indicated by using brackets. These specific elements are presented as mere examples in order to facilitate understanding, and thus, should not be interpreted as any limitation to the accompanying claims.

### BRIEF DESCRIPTION OF THE DRAWINGS

FIG. 1 is an axial cross-sectional view of an exhaust purifying device for an internal combustion engine according to one embodiment of the present, disclosure.

FIG. 2 is a partially enlarged view showing the proximity of a buffer member of the exhaust purifying device of FIG. 1.

FIG. 3 is a partial view of the axial cross-section of the exhaust purifying device for an internal combustion engine according to another embodiment of the present disclosure.

FIG. 4 is a partial view of the axial cross-section of the exhaust purifying device for an internal combustion engine according to still another embodiment of the present disclosure.

FIG. 5 is a plan view showing one example of the buffer member applied to the exhaust purifying device for an internal combustion engine according to the embodiment of the present disclosure.

FIG. 6 is a plan view showing another example of the buffer member applied to the exhaust purifying device for an internal combustion engine according to the embodiment of the present disclosure.

FIG. 7A is a partial cross-sectional perspective view showing a state in which the buffer member is fitted into a setting member of the exhaust purifying device for an internal combustion engine according to still another embodiment of the present disclosure.

FIG. 7B is an enlarged view of a cross-sectional part in FIG. 7A.

FIG. 7C is a partial cross-sectional perspective view showing a state in which the set member in a condition of FIG. 7A is welded to an edge ring member.

FIG. 7D is an enlarged view of a cross-sectional part in FIG. 7C.

FIG. 7E is a partial cross-sectional view showing a state in which the edge ring member in a condition of FIG. 7C is welded to a case member.

FIG. 8 is a partial cross-sectional view showing a state in which the setting member is welded to the edge ring member of the exhaust purifying device for an internal combustion engine according to still another embodiment of the present disclosure.

FIG. 9A is a partial cross-sectional view showing the relation between a fitting body of the setting member and the buffer member and the edge ring member in one working process of the exhaust purifying device for an internal combustion engine according to still another embodiment of the present disclosure.

FIG. 9B is a partial cross-sectional view showing the relation between the fitting body of the setting member and the buffer member and the edge ring member in a working process later than that in FIG. 9A.

FIG. 9C is a view for explaining a situation in which a pressing force is applied to the edge ring member to allow it to deform to a state of FIG. 9B from a state of FIG. 9A.

### DETAILED DESCRIPTION

Preferred embodiments of the present disclosure will now be described below in detail for clarification with reference to the accompanying drawings.

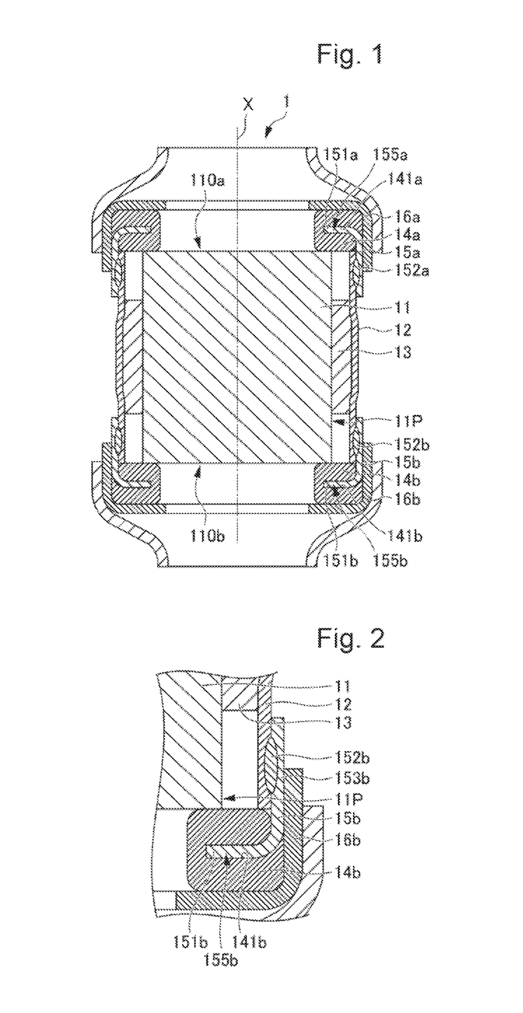

FIG. 1 is an axial cross-sectional view of an exhaust purifying device for an internal combustion engine according to an embodiment of the present disclosure. An exhaust purifying device 1 for an internal combustion engine according to the present embodiment is a gasoline particulate filter (hereinafter referred to as “GPF”) which is provided in an exhaust pipe of an internal combustion engine (not shown) to collect particulate matter (hereinafter referred to as “PM”) in exhaust circulating in the exhaust pipe.

The exhaust purifying device 1, in one embodiment, is provided in an exhaust pipe extending downward along a side of a front side of a vehicle with a gasoline engine, right under a gasoline engine (not shown). Namely, the exhaust purifying device 1 is provided in the exhaust pipe in a state in which the flow direction of exhaust is set downward.

As shown in FIG. 1, the exhaust purifying device 1 is provided with a honeycomb carrier 11 and a case member 12.

The honeycomb carrier 11 is provided with a plurality of cells extending through from an inflow side edge (end) surface 110a to an outflow side edge (end) surface 110b of the exhaust which are one and the other edge surfaces in the central axis X direction and become a flow passage of the exhaust, and porous partitions designed to form compartments in the cells.

The honeycomb carrier 11 is formed in a column-shape which is circular in cross-section. However, any honeycomb carrier can be applied as long as it is column-shaped, for example, it may be formed in a shape having an ellipse or a plurality of circular arcs in the cross-section of the radial direction.

The shape of each cell is formed in a square column shape which is square in cross-section, but it may be formed in a polygonal shape.

The honeycomb carrier 11 is formed by porous, fire-resistant ceramics composed of a cordierite. The honeycomb carrier 11 composed of the cordierite is obtained by a firing process after it is integrally formed by an extrusion molding method. During firing, an outer envelope is formed at the same time. Accordingly, since the honeycomb carrier 11 of the present embodiment is provided in such a manner that the outer circumferential side surface is covered with the outer envelope, catalysts do not leak from the outer circumferential side surface in a catalyst holding process or the exhaust does not leak from the outer circumferential side surface during use.

The pore size and porosity of the honeycomb carrier 11 can be set properly within the range in which the partitions serve as a filter medium for filtering PM in the exhaust.

The honeycomb carrier 11 carries an exhaust purifying catalyst for purifying the exhaust. Specifically, the honeycomb carrier 11 of the present embodiment carries a three-way catalyst for purifying HC, CO and NOx in the exhaust. The three-way catalyst including at least one precious metal of Pt, Pd and Rh is preferably used.

The case member 12 is formed in a cylindrical shape which is toric in cross-section and is adapted to house the above described honeycomb carrier 11 therein. However, any case member 12 can be applied as long as it is cylindrical according to the shape of the honeycomb carrier 11, for example, it may be formed in a shape having an elliptical annular shape or a plurality of circular arc rings in the cross-section of the radial direction.

This case member 12, for example, is made of metal such as SUS.

The case member 12 is a case member of a clamshell type composed of a half-case which was divided in two parts in the circumferential direction along the central axis X direction (the vertical direction of FIG. 1). Namely, the case member 12 is integrally formed by butt welding the ha If-cases divided in two parts.

The honeycomb carrier 11 of which the outer shape in FIG. 1 is substantially column-shaped is housed in the case member 12 through a mat-like holding member 13. The holding member 13 is provided between the honeycomb carrier 11 and the case member 12 so as to surround the outer circumference of the honeycomb carrier 11 and holds a position of the honeycomb carrier 11 in a plane direction perpendicular to the central axis X within the case member 12 in a predetermined regular position.

Materials with heat resistance, vibration resistance and sealing efficiency are used for the holding member 13. Specifically, in addition to ceramic fibers such as alumina fiber, silica fiber, alumina-silica fiber and glass ceramic fiber, a metal mesh or the like are also used.

Also, a buffer member 14a is provided at a peripheral edge of the inflow side edge surface 110a of the honeycomb carrier 11 so as to regulate the movement of the honeycomb carrier 11 in the central axis X direction. Similarly, a buffer member 14b is provided at the peripheral edge of the outflow side edge surface 110b so as to regulate the movement of the honeycomb carrier 11 in the central axis X direction. The buffer member 14a and the buffer member 14b are formed in an annular shape along each periphery of the inflow side edge surface 110a and the outflow side edge surface 110b of the honeycomb carrier 11.

Further, in response to the buffer member 14a, a setting member 15a is provided so as to regulate the position of the buffer member. The setting member 15a is constituted in such a manner that one part thereof is secured to the case member 12 and a position regulation part 151a formed on the other part contacts the buffer member 14a to regulate the movement of the buffer member 14a.

Similarly, in response to buffer member 14b, a setting member 15b is provided so as to regulate the position of buffer member 14b. The setting member 15b is constituted in such a manner that one part thereof is secured to the case member 12 and a position regulation part 151b formed on the other part contacts the buffer member 14b to regulate the movement of the buffer member 14b.

The annular buffer members 14a, 14b are respectively provided, on their outer circumferential sides, with recesses 14la, 141b into which the above described position regulation parts 151a, 151b of the corresponding setting members 15a, 15b are fitted.

In addition, an edge ring member 16a is fitted so as to cover each part of the buffer member 14a and the setting member 15a from outside. In the same way, an edge ring member 16b is fitted so as to cover one part of the buffer member 14b and the setting member 15b from outside.

Next, referring to both FIGS. 1 and 2, the exhaust purifying device for an internal combustion engine according to the embodiment of the present disclosure is described below in detail.

FIG. 2 is a partially enlarged view showing the proximity of the buffer member of the exhaust purifying device of FIG. 1.

In FIGS. 1 and 2, same reference numerals are given to the corresponding sections.

As shown in FIGS. 1 and 2, the position regulation parts 151a, 151b of the setting members 15a, 15b are provided in such a manner that their edge sections facing toward the central axis X of the honeycomb carrier 11 reach a position of the inner circumferential side than the outer circumferential surface 11P of the honeycomb carrier 11. Specifically, at least one part of the fitting sections 155a, 155b of the position regulation parts 151a, 151b to be fitted into the recesses 141a, 141b of the buffer members 14a, 14b reaches a position of the inner circumferential side than the outer circumferential surface 11P of the honeycomb carrier 11.

Also, in the embodiment of FIGS. 1 and 2, the setting members 15a, 15b are composed of the different members from and the same material as the case member 12 and are welded to the case member 12 at welding spots 152a, 152b.

FIG. 2 shows the detailed structure to which reference numerals are given. The setting member 15b is provided in such a manner that one part of a cylindrical section 153b situated so as to surround the outer circumferential surface of the downstream side of the exhaust of the case member 12 is welded to the case member 12 at a welding spot 152b.

The setting member 15b is provided in such a manner that the other part extending further to the downstream side of the exhaust from the cylindrical section 153b is bent in an arc shape to be held in reduced diameter state. A part facing further toward the central axis X of the honeycomb carrier 11 from the reduced diameter section contacts the buffer member 14b to form the position regulation part 151b for regulating the movement of the buffer member 14b.

As described above, the extended part of the position regulation part 151b toward the inner diameter side is fitted, with almost no space, into the recess 141b formed on the outer circumferential surface side of the buffer member 14b. The tip section of the part fitted in this manner facing toward the central axis X of the honeycomb carrier 11 reaches a position of the inner circumferential side than the outer circumferential surface 11P of the honeycomb carrier 11.

Also, in FIG. 2, each buffer member 14a, 14b situated on the upstream and downstream sides of the exhaust in FIG. 1, the buffer member 14b on the downstream side, and the setting member 15b corresponding to the buffer member of the setting members 15a, 15b corresponding to the buffer members are shown in detail. Since the buffer member 14a on the upstream side and the setting member 15a corresponding thereto are substantially the same as in the case of the downstream side described above, description is omitted. Namely, although not shown in the figure, the setting member 15a corresponding to the setting member 15b is provided with a position regulation part 151a corresponding to the position regulation part 151b. Needless to say, the recess 141a corresponding to the recess 141b is formed on the outer circumferential side of the buffer member 14a corresponding to the buffer member 14b.

Next, effects of the exhaust purifying device for an internal combustion engine as one embodiment of the present disclosure described referring to FIGS. 1 and 2 will now be described below.

In the device of FIGS. 1 and 2, the annular buffer members 14a, 14b are provided on each peripheral edge of the inflow side edge surface 110a and the outflow side edge surface 110b of the honeycomb carrier 11 so as to regulate the movement of the honeycomb carrier 11 in the central axis X direction. Further, the setting members 15a, 15b are provided so as to regulate the movement of the buffer members 14a, 14b. The setting members 15a, 15b are provided in such a manner that one part of the setting members is secured to the case member 12 and provided with the position regulation parts 151a, 151b adapted to contact the buffer members 14a, 14b for position regulation. The buffer members 14a, 14b are provided, on their outer circumferential sides, with recesses 141a, 141b into which the position regulation parts 151a, 151b of the setting members 15a, 15b are fitted.

Accordingly, the buffer members 14a, 14b is provided in such a manner that its position is regulated under the sufficient regulation force by allowing the position regulation parts 151a, 151b of the setting members 15a, 15b to be fitted into the recesses 141a, 141b. Therefore, without using a technique like welding which has a problem with durability, the buffer members 14a, 14b can be maintained in a predetermined position and as a result, the exhaust purifying device 1 is excellent in durability. Also, without performing welding or the like, since the position regulation parts 151a, 151b of the setting members 15a, 15b is caused to be fitted into the recesses 141a, 141b of the buffer members 14a, 14b, a process for performing welding or the like can be omitted and production efficiency is good.

In particular, the edge sections of the position regulation parts 151a, 151b of the setting members 15a, 15b facing toward the central axis X of the honeycomb carrier 11 reach the position of the inner circumferential side than the outer circumferential surface 11P of the honeycomb carrier 11. For this reason, even though stress is applied from the honeycomb carrier 11 side, it is possible to effectively prevent the deformation or slip-off of the buffer members 14a, 14b.

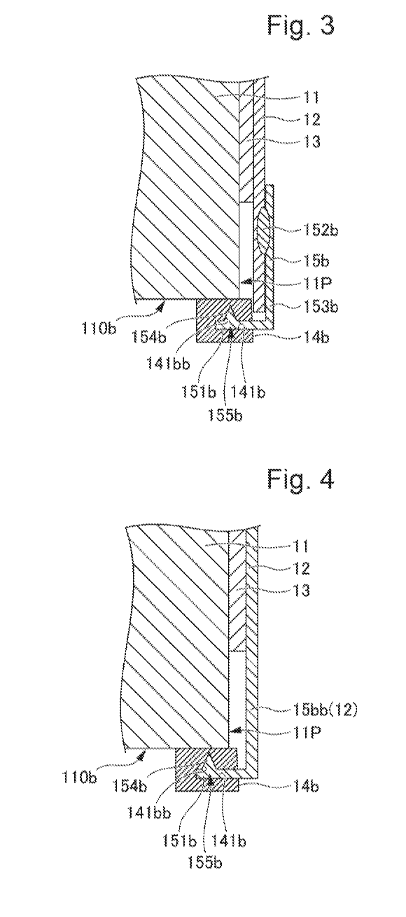

FIG. 3 is a partial view of the axial cross-section of the exhaust purifying device for an internal combustion engine according to another embodiment of the present disclosure.

In FIG. 3, the same reference numerals are given to the parts corresponding to FIGS. 1 and 2, and as for those corresponding parts, the description referring to FIGS. 1 and 2 are applied.

In the embodiment of FIG. 3, the difference from the embodiment of FIGS. 1 and 2 is that the setting member 15b is provided, at its position regulation part 151b, with a projection 154b projecting toward the honeycomb carrier 11. Moreover, the setting member 15a (not shown) in FIG. 3 is also provided, at its position regulation part 151a, with a projection 154a projecting toward the honeycomb carrier 11, but as for the corresponding parts which are readily estimated from the embodiment of FIG. 3, a description is omitted accordingly. The recess 141b on the buffer member 14b side is provided with recess section 141bb into which the projection 154b is fitted. Even in this case, at least each part of the fitting sections 155a, 155b of the position regulation parts 151a, 151b to be fitted into the recesses 141a, 141b of the buffer members 14a, 14b reach a position of inner circumferential side than the outer circumferential surface 11P of the honeycomb carrier 11.

Also, since the buffer member 14b is composed of the material which can be deformed by applying an adequate force, in a production process, the buffer member 14b is once caused to deform by applying force thereto and then, as shown in FIG. 3, the position regulation part 151b including the projection 154b is fitted, with no space, into the recess 141b including the recess section 141bb.

According to the embodiment of FIG. 3, in addition to the effects in the embodiment described referring to FIGS. 1 and 2, by allowing the projection 154b to strongly engage with the recess 141b of the buffer member 14b, it is possible to strongly prevent the deformation or slip-off of the buffer member 14b.

FIG. 4 is a partial view of the axial cross-section of the exhaust purifying device for an internal combustion engine according to still another embodiment of the present disclosure.

In FIG. 4, the same reference numerals are given to the parts corresponding to FIGS. 1, 2 and 3, and as for those corresponding parts, the descriptions referring to FIGS. 1, 2, and 3 are applied.

In the embodiment of FIG. 4, the difference from the embodiments of FIGS. 1, 2 and 3 is that the setting member 15bb is the same member as the case member 12. Even in this case, at least each part of the fitting sections 155a, 155b of the position regulation parts 151a, 151b to be fitted into the recesses 141a, 141b of the buffer members 14a, 14b reaches a position of the inner circumferential side than the outer circumferential surface 11P of the honeycomb carrier 11.

Since a part of the case member 12 itself constitutes the setting member 15bb, the number of parts is reduced and the number of welding spots is reduced and as a result, further improvement of production efficiency is attained.

The projection 154b (154a) in the embodiment of FIGS. 3 and 4 is provided in such a manner that its pointed section projects toward the honeycomb carrier 11. Accordingly, in the case where stress acts toward the buffer member 14b (14a) from the honeycomb carrier 11 side, the projection 154b (154a) is strongly fitted into the recess 141b (141a) of the buffer member 14b (14a). For this reason, even though the stress above acts, there is no risk of causing the buffer member 14b (14a) to deform and slip off. Also, even though an especially large amount of stress acts to cause the fitting section 155b (155a) of the setting members 15b (15a), 15bb (15aa) to deform outward, there is no risk of causing the buffer member 14b (14a) to displace and slip off.

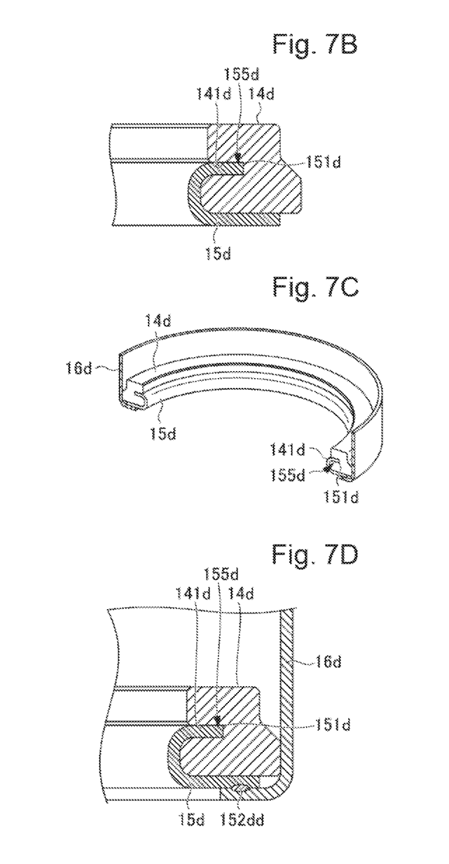

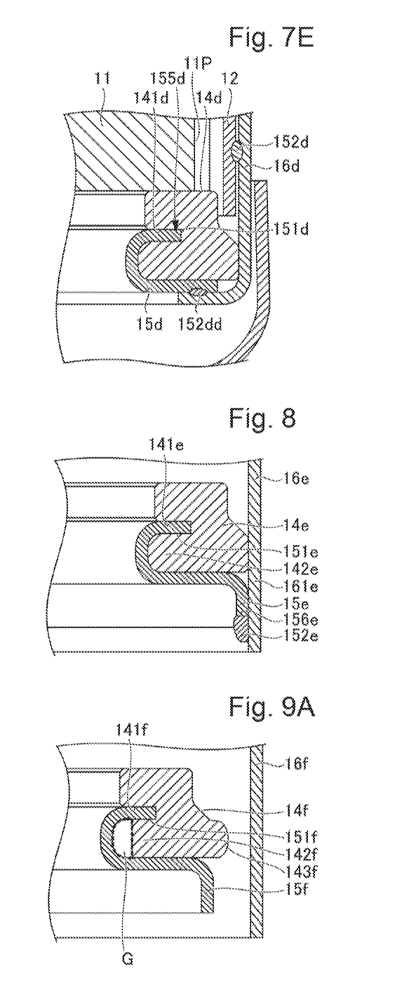

The projection 154b (154a) in the embodiments of FIGS. 3 and 4 is provided in such a manner that its pointed section projects toward the honeycomb carrier 11 (toward the upstream side which is the upper side of the figure), but the projecting direction of the projection is not limited to this and can be set in the opposite direction from the embodiment of FIGS. 3 and 4. In this respect, description will be made later with regard to the other embodiment shown in FIGS. 7A to 7E.

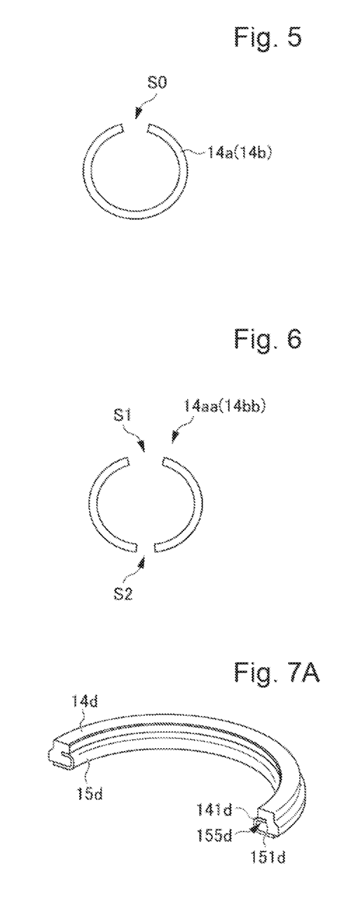

FIGS. 5 and 6 are plan views respectively showing one example and the other example of the buffer member applied to the exhaust purifying device for an internal combustion engine according to the embodiment of the present disclosure.

The buffer member 14a (14b) of FIG. 5 takes the forms shown in FIGS. 1 to 4 in a cross-sectional view, but, in planar view, that is, in a view of the honeycomb carrier 11 in the central axis X direction, is formed in a substantially annular shape and divided in one aperture S0.

Further, the buffer member 14aa (14bb) of FIG. 6 takes the forms shown in FIGS. 1 to 4 in a cross-sectional view, but, in planar view, that is, in a view of the honeycomb carrier 11 in the central axis X direction, is formed in a substantially annular shape and divided in two apertures S1, S2.

According to the embodiments to which such divided buffer members 14a (14b), 14aa (14bb) as shown in FIGS. 5 and 6 as a buffer member are applied, since the deformation of the buffer member is performed easily at assembling, production efficiency is good and it is possible to reduce distortion of the setting members 15a, 15b and the case member 12 at the time of hot working by absorbing the deformation at a part of the aperture.

Although not shown in the figure, the setting members 15a, 15b which take the forms shown in FIGS. 1 to 4 in a cross-sectional view is provided in such a manner that the position regulation part 151a, 151b are formed in an annular shape, in planar view, that is, in a view of the honeycomb carrier 11 in the central axis X direction and can take the form in which at least one part is divided.

In this case, since the deformation of the position regulation parts 151a, 151b in the setting members 15a, 15b is performed easily at assembling because of the existence of an aperture by the division, production efficiency is good and it is possible to absorb the deformation at a part of the aperture produced by the division, thereby being capable of reducing the distortion of the setting members 15a, 15b and the case member 12 at the time of hot working.

Here, still further embodiment of the present disclosure is described referring to FIGS. 7A to 7E.

FIG. 7A is a partially cross-sectional perspective view showing a state in which the buffer member is fitted into the setting member of the exhaust purifying device for an internal combustion engine according to still further embodiment of the present disclosure.

FIG. 7B is an enlarged view of a cross section of FIG. 7A.

FIG. 7C is a partially cross-sectional perspective view showing a state in which the setting member in a condition of FIG. 7A is welded to an edge ring member.

FIG. 7D is an enlarged view of a cross section of FIG. 7C.

FIG. 7E is a partially cross-sectional view showing a state in which the edge ring member in a condition of FIG. 7D is welded to a case member.

In FIGS. 7A to 7E, in the embodiments of the present disclosure, a state of the setting member and the buffer member disposed on the downstream side of the setting member and the buffer member which are symmetrically disposed on the upstream side and the downstream side (hereinafter properly referred to as “upstream side” and “downstream side”) in the flow of exhaust of the honeycomb carrier is shown. Since the setting member and buffer member disposed on the upstream side take on a symmetric appearance with those disposed on the downstream side, a detailed description is given below for the downstream side, but the setting member and the buffer member are also arranged in the same manner on the upstream side. In FIGS. 7A to 7E, the same reference numerals are given to the corresponding parts.

Also, FIGS. 7A to 7e partially show a production process in the embodiment of the exhaust purifying device for an internal combustion engine.

In FIGS. 7A and 7B, the setting member 15d and the buffer member 14d in the same production process are shown from a different viewpoint. In the process shown in FIGS. 7A and 7B, fitted into the arc-shaped (partially annular) setting member 15d is the corresponding arc-shaped (partially annular) buffer member 14d.

Specifically, the setting member 15d shown in the figure is provided to pair up with the corresponding arc-shaped (partially annular) setting member to have a toric shape.

Also, the buffer member 14d is provided to pair up with the corresponding arc-shaped (partially annular) buffer member to have a toric shape.

Namely, the setting member 15d and the buffer member 14d of FIG. 7A are one part of the setting member and the buffer member which form a torus as a whole and they are one part of the torus divided as shown in FIG. 6.

A cross-sectional view of FIG. 7B is a view of the arc-shaped (partially annular) setting member 15d and buffer member 14d in FIG. 7A in the cross-section of the radial direction.

As shown in FIGS. 7A and 7B, the setting member 15d contacts the inner circumferential side of the buffer member 14d, but its bottom side (the downstream side) goes around to the bottom surface side of the buffer member 14d and is bent outward in the radial direction to increase the diameter. On the other hand, the upper side (the upstream side) of the setting member 15d is bent toward a recess 141d which is a line of recessed groove formed toward the outside in the radial direction from the inner circumferential surface and then fitted into the recess 141d. This is a fitting section 155d in this example. A part of the setting member 15d which contacts the buffer member 14d to regulate the movement of the buffer member 14d is a position regulation part 15d. In this example, almost the entirety of the setting member 15d serves as the position regulation part 151d.

In the process of FIGS. 7A and 7B, as described above, the buffer member 14d is fitted into the setting member 15d to form a toroid and in the subsequent process shown in FIGS. 7C and 7d, an edge ring member 16d is welded to the outer circumferential side of this toroid.

Specifically, a fitting body of the arc-shaped (partially annular) setting member 15d and buffer member 14d of FIGS. 7A and 7B is provided to form one toroid in pairs by allowing the corresponding edges to abut each other. Next, as shown in FIG. 7C, the edge ring member 16d is disposed so as to surround the outer circumferential side of this toroid. With this arrangement, as shown in FIG. 7D, the setting member 15d and the edge ring member 16d of the toroid are welded at a welding spot 152dd.

In this case, the arc-shaped (partially annular) fitting body of the setting member 15d and the buffer member 14d which form one toroid in pairs has an arc-shaped (partially annular) form in which the toroid is divided respectively as shown in FIG. 6, but the edge ring member 16d is an integral member which is not divided in the circumferential direction.

As shown in FIG. 7D, the edge ring member 16d goes around toward the bottom surface (the downstream side edge surface) of the setting member 15d fitting into the buffer member 14d from a part contacting the outer circumferential surface of the buffer member 14d so as to form a welding spot 152dd at a contact section between the edge ring member and the bottom surface of the setting member 15d, wherein welding is performed at the welding spot 152dd.

Further, as shown in FIG. 7E, the edge ring member 16d which is in a condition of FIG. 7C is welded to the case member 12 at a welding spot 152d. In the example of FIG. 7E, there is formed a gap between the outer circumferential surface of an area of the buffer member 14d of which the outer circumference is reduced in diameter and the inner circumferential surface of the edge ring member 16d, and the edge of the case member 12 is provided to intrude into this gap downward. There is formed a welding spot 152d of the edge ring member 16d and the case member 12 at an area which is slightly upper (upstream side) than the lower end position of the case member 12 which entered into the gap downward as described above.

In the cross-sectional view of FIG. 7E, when following the cross-sectional shape of the position regulation part 151d of the setting member 15d toward the upper side (upstream side) from the outer circumferential end of the lower side (downstream side), the position regulation part extends to the inner circumferential side than the outer circumferential surface of the honeycomb carrier 11 facing toward the central axis X of the honeycomb carrier (FIG. 1) from its outer circumferential end, then rises along the inner circumferential surface of the buffer member 14d and then, it is folded back to the outside in a U-shape. In this connection, the recess 141d into which the fitting section 155d of the position regulation part 151d is fitted is formed on the inner circumferential side of the buffer member 14d. In other words, the position regulation part 151d (and its fitting section 155d) of the setting member 15d is fitted into the recess 14d formed on the inner circumferential side of the buffer member 14d. Fitted on the outer circumferential side of the buffer member 14d and the setting member 15d fitted in this manner is the edge ring member 16d. As described above, the edge ring member 16d is connected, on a downward side, to the setting member 15d by the welding spot 152dd and, on the upper side, to the case member 12 by the welding spot 152d.

Accordingly, in the embodiments of the FIGS. 7A to 7E, it is possible to allow the setting member 15d to surely hold the recess 141d of the buffer member 14d, thereby being capable of holding the buffer member 14c more strongly. Thus, even though stress is applied from the honeycomb carrier 11 side, it is possible to effectively prevent the deformation or slip-off of the buffer member 14d. Also, workability during manufacture becomes excellent.

Although not shown in the figure, but a projection of which the projecting direction of the pointed section is opposite (a downward direction in FIG. 7E) to that of FIGS. 3 and 4 is provided on the lower surface (a surface of the downstream side) of the fitting section 155d of the setting member 15d so that this projection may intrude in the buffer member 14d. In this case, in FIG. 7E, part of the buffer member 14d is fitted into the U-shaped section of the position regulation part 151d 6when seen in the cross-section and as a result, a positional displacement of that part of the buffer member can be strongly prevented by the projection. Accordingly, there is no risk of causing the buffer member 14d to be turned up from the position regulation part 151d and of causing disconnection or slip-off of the buffer member.

FIG. 8 is a partial cross-sectional view showing a state in which a setting member is welded to an edge ring member of the exhaust purifying device for an internal combustion engine according to still another embodiment of the present disclosure.

In FIG. 8, in the embodiment of the present disclosure, a state of each member disposed on the downstream side, of an edge ring member, a setting member and a buffer member which are symmetrically disposed on the upstream side and the downstream side in a flow of exhaust of the honeycomb carrier, is shown.

Since the edge ring member, the setting member and the buffer member disposed on the upstream side take on the symmetric aspect with each corresponding member disposed on the downstream side as shown in FIG. 8, the detailed description about a structure in the downstream side is given below and the description about the upstream side is omitted.

Even in the embodiment of FIG. 8, as is the case with the embodiment of FIG. 7E, the buffer member 14e is fitted onto the outer circumferential side of the setting member 15e. In this state, a circular recess 141e of a constant depth is formed toward the radial outside on the inner circumferential surface side of the annular buffer member 14e and then, a corresponding circular position regulation part 151e of the setting member 15e is fitted into the circular recess. An edge ring member 16e of FIG. 8 has a cylindrical section 161e formed in a cylindrical shape. As described above, relative to an integrally fitted fitting body of substantially annular setting member 15e and buffer member 14e, the edge ring member 16e is provided to fit onto the outer circumferential side of the fitting body.

The setting member 15e in the embodiment of FIG. 8, in a cross-sectional view of the honeycomb carrier 11 (see FIGS. 1 and 2) in the radial direction, extends toward the outer periphery along the bottom surface side of the buffer member 14e after surrounding, in a U-shape, a position-regulated part 142e on the lower side of a recess 141e of the buffer member 14e from the outer circumferential end side of the position regulation part 151e. The setting member 15e extends like this and reaches an area facing the inner circumferential surface of the cylindrical section 161e of the edge ring member 16e. Further, from this section, the setting member 15e extends in the direction away (downward in FIG. 8) from the outflow side edge surface 110b of the honeycomb carrier 11 along the inner circumferential surface of the cylindrical section 161e to form an extension part 156e along the edge ring member 16e (and its cylindrical section 161e).

The setting member 15e is welded to the edge ring member 16e (and its cylindrical section 161e) at a location near the extended end of the extension part 156e to form a welding spot 152e.

In the embodiment of FIG. 8, since the welding spot 152e is away from the buffer member 14e, welding of the edge ring member 16e and the setting member 15e is easily performed and the buffer member 14e is less subject to heat damage.

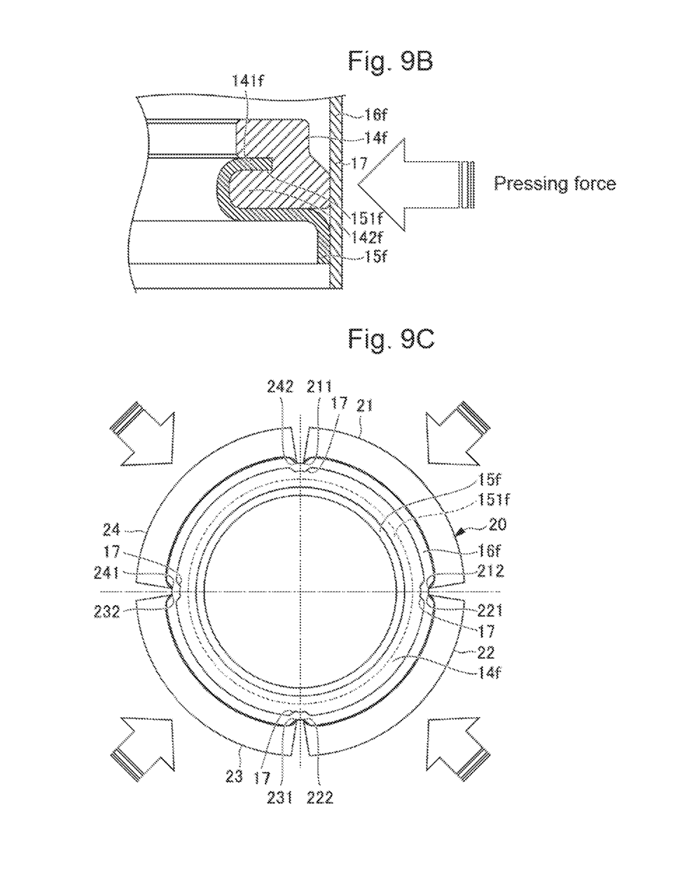

FIG. 9A is a partial cross-sectional view showing the relation between a fitting body of a setting member and a buffer member and an edge ring member in one working process of the exhaust purifying device for an internal combustion engine according to still another embodiment of the present disclosure.

In FIG. 9A, in the embodiment of the present disclosure, a state of each member disposed on the downstream side of, an edge ring member, a setting member and a buffer member which are symmetrically disposed on the upstream side and the downstream side in a flow of exhaust of a honeycomb carrier, is shown.

Since the edge ring member, the setting member and the buffer member disposed on the upstream side take on a symmetric aspect with each corresponding member disposed on the downstream side as shown in FIG. 9A, the detailed description about a structure in the downstream side is given and the description about the upstream side is omitted. Omission of the description like this can also applied to FIGS. 9B and 9C described later.

Even in a state of FIG. 9A, a buffer member 14f is fitted onto the outer circumferential side of a setting member 15f. In this state, a circular recess 141f of a constant depth is formed toward the radial outside on the inner circumferential surface side of an annular buffer member 14f and then, a corresponding circular position regulation part 151f of the setting member 15f is fitted into the recess.

Also, in the working process of FIG. 9A, the exhaust purifying device for an internal combustion engine is in the unfinished condition. Namely, in FIG. 9A, relative to the fitting body of the setting member 15f and the buffer member 14f, the edge ring member 16f to be fitted onto the outer circumferential side of the fitting body is in a state in which it is not yet in contact with the fitting body.

In a state of FIG. 9A, as is the case with FIG. 8, the setting member 15f, in a cross-sectional view of the honeycomb carrier 11 (see FIGS. 1 and 2) in the radial direction, extends toward the outer periphery along the bottom surface side of the buffer member 14f after surrounding, in a U-shape, the position-regulated part 142f on the lower side of the recess 141f of the buffer member 14f from the outer circumferential end side of the position regulation part 151f.

In the case of FIG. 8 described above, in this state, the position-regulated part 142e is provided in such a manner that the tip of the inner circumferential side of the position-regulated part contacts an opposite surface of the setting member 15e in a U-shape and as a result, the buffer member 14e (and its position-regulated part 14e) is fitted into the setting member 15e with no space. For this reason, the buffer member 14e is sufficiently and firmly held in position by the setting member 15e. Accordingly, troubles such that the buffer member 14e rotates in the circumferential direction relative to the setting member 15e do not occur.

On the other hand, in FIG. 9A, there is provided a gap G between the buffer member 14f (and its position-regulated part 142f) and the opposite surface of the U-shaped setting member 15f. Also, the buffer member 14f is provided with a projection 143f projecting outward to the extent that the outer circumferential side of the position-regulated part 142f corresponds to the gap G.

In a state of FIG. 9A, since there is the gap G between the buffer member 14f (and its position-regulated part 142f) and the setting member 15f, a position holding force of the setting member 15f relative to buffer member 14f is not enough. Accordingly, there is a risk that the buffer member 14f rotates in the circumferential direction relative to the setting member 15f.

FIG. 9B is a partial cross-sectional view showing the relation between a fitting body of a setting member and a buffer member and an edge ring member in a working process later than that of FIG. 9A.

FIG. 9B shows a cross-section including a projection 17 which is formed by applying a pressing force (described later) to a peripheral wall of the edge ring member 16f situated on the outer circumferential side of a fitting body of the setting member 15f and the buffer member 14f and allowing the edge ring member to plastically deform in the direction to reduce its diameter. The projection 17 formed on tho peripheral wall of the edge ring member 16f has a projection toward the opposite part of the buffer member 14f (an area which was a projection 143f in FIG. 9A). For this reason, the projection 17 formed on the peripheral wall of the edge ring member 16f presses the projection 143f of the buffer member 14f, the buffer member 14f (and its position-regulated part 142f) is caused to intrude the recess of a U-shaped cross-section of the setting member 15f. As a result, the gap G of FIG. 9A is filled up by the position-regulated part 142f of the buffer member 14f and the buffer member 14f is brought into close contact with setting member 15f. Thus, the position holding force of the setting member 15f relative to the buffer member 14f becomes enough. In this manner, there is no risk that the buffer member 14f rotates in the circumferential direction relative to the setting member 15f.

FIG. 9C is a view for explaining a situation in which a pressing force is applied to the edge ring member to allow it to deform to a state of FIG. 9B from a state of FIG. 9A.

FIG. 9C is a view of the embodiment of the present disclosure of FIG. 9B when seen in the central axis X direction of the honeycomb carrier 11 (see FIGS. 1 and 2).

The outer periphery of the cylindrical edge ring member 16f is divided into quarters in the circumferential direction and arc-shaped split patterns 21, 22, 23 and 24 of a constant thickness are disposed for an equally divided zone. The first split pattern 21 has a pressing part 211, 212 projecting toward the inner periphery at each end. In the same way, the second split pattern 22 has a pressing part 221, 222, the third split pattern 23 has a pressing part 231, 232, and the fourth split pattern 24 has a pressing part 241, 242, respectively. The split patterns 21, 22, 23, and 24 are made so each pattern can be displaced by a driving mechanism (not shown) in the diameter reducing direction and form a pressing jig 20 as a whole.

When the split patterns 21, 22, 23, and 24 for the pressing jig 20 synchronize to displace in the diameter reducing direction, there is formed one projection 17 by plastic deformation on the periphery wall of the edge ring member 16f by the pressing parts 211 and 242 described above. In the same way, by the pressing parts 212 and 221, the pressing parts 222 and 231 and the pressing parts 232 and 241, each corresponding projection is formed and there are formed four projections 17 on the peripheral wall of the edge ring member 16f at regular intervals in the circumferential direction.

As shown in FIG. 9B, the projection 143f of the buffer member 14f is pressed by each of the four projections 17 of the edge ring member 16f and the gap G of FIG. 9A is filled up by the position-regulated part 142f of the buffer member 14f, thereby causing the buffer member 14f to bring into a close contact with the setting member 15f. Thus, as described above, the position holding force of the setting member 15f relative to the buffer member 14f is made sufficient and there is no risk that the buffer member 14f rotates in the circumferential direction.

Also, the detailed description is given in the above mainly for the exhaust purifying device in which the buffer member is provided on each peripheral edge of the inflow side edge surface and the outflow side edge surface of the honeycomb carrier, but it is also possible to provide the buffer member on the periphery edge of the edge surface of at least one side of the inflow side edge surface and the outflow side edge surface of the honeycomb carrier. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. An exhaust purifying device for an internal combustion engine provided in an exhaust passage of the internal combustion engine to purify exhaust of the internal combustion engine comprising:
a column-shaped honeycomb carrier comprising a plurality of cells extending from an exhaust inflow side end surface of the honeycomb carrier to an exhaust outflow side end surface of the honeycomb carrier and each being a flow passage of the exhaust, the plurality of cells being defined by porous partitions;
a cylindrical case member configured to house the honeycomb carrier;
a holding member provided between the honeycomb carrier and the case member to surround an outer circumference of the honeycomb carrier;
a buffer member provided on a peripheral edge of at least one of the inflow side end surface and the outflow side end surface of the honeycomb carrier so as to regulate movement of the honeycomb carrier along a central axis direction of the honeycomb carrier; and
a setting member secured to the case member and including a position regulation member configured to contact the buffer member to regulate movement of the buffer member;
wherein the buffer member includes a recess into which the position regulation member of the setting member is fitted.

2. The exhaust purifying device for an internal combustion engine according to claim 1, wherein the position regulation member of the setting member includes a fitting section fitted into the recess, and at least one part of the fitting section reaches a position located radially inner than the outer circumferential surface of the honeycomb carrier.

3. The exhaust purifying device for an internal combustion engine according to claim 1, wherein the position regulation member of the setting member, in a axial cross-sectional view of the honeycomb carrier, extends toward the central axis of the honeycomb carrier from an outer circumferential end thereof to a position located inner than the outer circumferential surface of the honeycomb carrier and being folded back toward the outer circumferential end thereof.

4. The exhaust purifying device for an internal combustion engine according to claim 1, further comprising an edge ring member with a cylindrical section fitted onto the outer circumferential surface of at least one of the buffer member and the setting member, and the setting member, in an axial cross-sectional view of the honeycomb carrier, includes an extension extending in a direction away from the honeycomb carrier along an inner circumferential surface of the cylindrical section of the edge ring member.

5. The exhaust purifying device for an internal combustion engine according to claim 1, wherein the position regulation member of the setting member is provided with a projection.

6. The exhaust purifying device for an internal combustion engine according to claim 1, wherein the buffer member has an annular shape in a view showing an end surface of the honeycomb carrier and at least one part of the annular buffer member is divided.

7. The exhaust purifying device for an internal combustion engine according to claim 1, wherein the setting member is a part of the case member.

8. The exhaust purifying device for an internal combustion engine according to claim 1, wherein the position regulation member of the setting member has an annular shape in a view showing an end surface of the honeycomb carrier and at least one part of the annular regulation member is divided.

9. The exhaust purifying device for an internal combustion engine according to claim 1, wherein the honeycomb carrier is a gasoline particulate filter.

10. The exhaust purifying device for an internal combustion engine according to claim 4, wherein at least a part of a peripheral wall of the edge ring member is provided with a projection projecting toward the buffer member.

11. The exhaust purifying device for an internal combustion engine according to claim 4, wherein the extension extends in the direction away from the honeycomb carrier along the central axis direction of the honeycomb carrier.

12. The exhaust purifying device for an internal combustion engine according to claim 6, further comprising an edge ring member with a cylindrical section fitted onto the outer circumferential surface of the buffer member.
